(19) United States
(12) Patent Application Publication
(10) Pub. No.: US 2005/0224562 A1
(43) Pub. Date: Oct. 13, 2005

(54) Apparatus and method for forming a weld joint having improved physical properties

(76) Inventor: Paul S Prevey, Cincinnati, OH (US)

Correspondence Address: SCOTT EVANS, 1252 COUNTRY HILLS DR., SANTA ANA, CA, 92705, US

(21) Appl. No.: 10/508,882

(22) PCT Filed: Mar. 25, 2003
(86) PCT No.: PCT/US03/08747

§ 371 Date: Apr. 25, 2005

Related U.S. Application Data
(60) Provisional application No. 60/367,623, filed on Mar. 26, 2002.

(51) Int. Cl. B23K 28/00

(52) U.S. Cl. 228/233.1

(57) ABSTRACT

The method and apparatus for performing the method of forming a weld joint of the present invention utilizes welding apparatus (100) having welded tool (102) and a compression tool (106) for inducing a layer of residual compressive stress along the surface of the weld line (18) and any heat affected regions with a controlled amount of cold working and surface hardening. In a preferred embodiment of the invention the compression tool (106) utilizes a single-point burnishing process to provide deep compression within the weld joint (20) with a minimal amount of cold working and surface hardening.

### CROSS REFERENCE TO RELATED APPLICATION

This application claims benefit of International Application No. PCT/US02/35214 filed Nov. 1, 2002, under the Patent Cooperation Treaty and to U.S. Provisional Application No. 60/367,623 filed Mar. 26, 2002.

### TECHNICAL FIELD

This invention relates to an apparatus and a method for forming a weld joint having improved physical properties and, more particularly, to a method of forming a weld joint utilizing a controlled method of inducing a specific compressive residual stress pattern and degree of cold working along the welding line to improve the physical properties of the weld.

### BACKGROUND OF THE INVENTION

In the manufacture and construction of many types of structures, welding, such as gas welding, arc welding, resistance welding, thermite welding, laser welding, and electron-beam welding, has reduced or replaced the use of various types of fastening methods, such as bolting, riveting and the like. Such welding techniques either involve the complete fusion of material forming a liquid state which subsequently solidifies producing altered microstructures and properties, or they involve a solid state welding process, but again producing a highly altered metallurgical state. The particular welding process best suited to join two pieces of metal depends on the physical properties of the metals, the specific use to which they are applied, and the production facilities available.

Unfortunately, several significant problems have limited the application of welding for certain manufacturing processes. One problem generally associated with welding is that the temperature required to melt or plasticize the parent materials typically reduces their yield strength. Another common problem associated with welding is the formation of tensile residual stresses created in the workpieces during the welding process by the expansion and then contraction of the fusion or plasticized zoned and regions adjacent to the weld joint.

Such tensile residual stresses are well known to reduce both fatigue life and increase sensitivity to corrosion-fatigue and stress corrosion cracking in a wide variety of materials.

It has also been found that micro-segregation kinetics found in some aluminum alloys, typically used in the aircraft industry, are sufficiently rapid such that stress corrosion resistance is reduced even after a short thermal transient. Further, where two different workpieces having different sizes are welded together, any residual stress is amplified due to the difference in heat capacity between the two workpieces. Another problem associated with many welding processes is the production of flash or excess material at the edge of the fusion or stir zone. Fatigue crack initiation typically occurs out of this area and is usually associated with the mechanical discontinuity at the edge or “toe” of the weld. This edge or “toe” has been found, in virtually all types of welds, to be the area where the highest tensile residual stresses are found.

Unfortunately, until now, there is no direct and cost effective method of restoring yield strength and improving the corrosion resistance of a weld joint. While acceptable corrosion resistance can be achieved by post-weld induction heat treatment, this technique is economically and technically impractical for all but the smallest and simplest of geometric shapes. Induction heating is also not easily controlled spatially and often results in overheating the material around the weld. While tensile stresses may be reduced or eliminated, compressive stresses are not easily induced by heat treatment techniques, except in special cases such as internally cooled tubular (pipe) weldments. Other material properties, such as yield strength, are also difficult to improve. Further, local heating by induction, or other means, can result in distortion and an increase tensile residual stresses elsewhere in the workpiece.

Corrosion resistance of a weld joint may also be improved by applying a coating, such as paint, electroplating or galvanizing, to all susceptible surfaces. However, such coatings also require a second independent process, which significantly increases the cost and production time. Further, such coatings provide only a superficial protective layer and do not protect surfaces that cannot be accessed, and protection of the surface is lost if the coating is broken or deteriorates during service.

Methods of inducing compressive stresses along the surfaces of a workpiece have been used to improve the fatigue life and corrosion resistance in the surface of a final part. One such method that has been utilized for inducing a layer of compressive stress in the surface of a workpiece to improve the fatigue life and corrosion resistance of the final part is burnishing. The generally accepted practice for burnishing utilizes repeated deformation of the surface of the workpiece, in order to deliberately cold work the surface of the material to increase the yield strength. Yielding the surface of the material in tension so that it returns in a state of compression following deformation develops compressive stresses. Unfortunately however, excess cold working may produce tensile surface stresses or spalling damage and may leave the surface susceptible to overload and thermal relaxation.

Other methods commonly used in the industry to induce compressive stress in the surface of a part include shot peening, whereby a plurality of metallic or ceramic pellets are projected mechanically or through air pressure to impinge the surface of a workpiece, and gravity peening, whereby pellets are dropped from a predetermined distance onto the surface of the workpiece. While shot peening and gravity peening may be used for inducing compressive residual stresses along the surface of the weld joint, unfortunately, shot peening and gravity peening also impart an uncontrolled amount of cold work making it difficult to optimize the physical properties of the weld. Further, the degree of cold working of the material by shot peening or gravity peening is relatively high, which may be undesirable for many applications. The shot or gravity peening induced compressive residual stresses are relatively shallow, affording limited benefit in arresting fatigue or stress corrosion cracks because the shallow compressive layer may be lost to wear or corrosion in service. Shot peening and gravity peening also produce a poor surface finish further making the processes unacceptable for many applications. It is also known that the beneficial effects produced by shot peening and gravity peening are generally lost as the pattern of compression relaxes with time in elevated temperature service.

It should now be apparent that until now, in addition to the problems identified above, all post welding procedures have required a second-pass process that significantly adds to the cost of manufacturing, since it takes more time and effort to produce a finished part than the time required for those parts not needing post welding treatment. Depending on the size, or number of parts, or the location of the weld, such increase in time and cost associated with a second-pass process often makes post-welding treatment impractical. In addition, until now, such methods for inducing compressive stress along the surface of a joint line in a prescribed pattern have not been used as a facet of the welding process.

Consequently, a need exists for a relatively inexpensive and fast method, and an apparatus for implementing the method, of forming a weld joint having a selected pattern of compressive residual stress and cold working along the surface of the weld joint, and the regions adjacent to the weld line, which is effective for improving the physical properties of the weld joint and the final part or product. In addition, a need exists for an apparatus and method of forming a weld joint that does not require the performance of a second-pass process or require the use of a second machine.

### DISCLOSURE OF THE INVENTION

The novel method of forming a weld joint of the present invention comprises the steps of performing a welding operation along a weld line to join two or more workpieces together; and performing a compression operation to induce a deep layer of compression in the surfaces of the workpieces to improve the material properties of the final product. In a preferred embodiment of the invention, the welding operation forms regions of elevated surface temperature along the workpieces, and the compression operation is performed along the regions to produce deep compression.

In another preferred embodiment of the invention, the method of forming a weld joint further comprises the step of using x-ray diffraction for determining the desired compressive stress pattern and amount of cold working and surface hardening for optimizing the physical properties of the weld joint and the finished product.

In another embodiment of the invention, the method of forming a weld joint further comprises the step of varying the amount of cold working to achieve the desired physical properties of the weld joint.

In another preferred embodiment of the invention, the method of forming a weld joint comprises the step of inducing a pattern of compressive residual stress with a minimal amount of cold working along a selected region.

In another preferred embodiment of the invention, the method of forming a weld joint comprises the step of inducing a pattern of compressive residual stress with less than about 5 percent cold working along the selected region.

In another preferred embodiment of the invention, the method of forming a weld joint comprises the step of inducing a pattern of compressive residual stress with less than about 2 percent cold working along the selected region.

In another preferred embodiment of the invention, the method of forming a weld joint comprises the step of inducing a pattern of compressive residual stress and varying amounts of cold working to achieve the desired physical properties of the weld joint and the final part.

In another preferred embodiment of the invention, the method of forming a weld joint comprises the step of utilizing a compression tool having a single-point of contact means for applying a force along the weld line to produce a zone of deformation having a deep layer of compression within the weld joint.

In another preferred embodiment of the invention, the method of forming a weld joint comprises the step of passing a compression tool in a predetermined pattern across the weld line such that the zones of deformation formed by each pass of the compression tool overlap in a controlled manner.

In another preferred embodiment of the invention, the method of forming a weld joint comprises the steps of predetermining and adjusting the application force to be applied along the weld line any heat affected regions; and using a programmable control unit to direct a compression tool in a predetermined pattern over the weld line and regions adjacent to the weld line to provide the maximum compressive residual stress with the minimum amount of cold working and surface hardening.

In another preferred embodiment of the invention, the method of forming a weld joint comprises the step of using a control device for automatically controlling the movement and position of a welding tool.

In another preferred embodiment of the invention, the method of forming a weld joint comprises the step of using a control device for automatically controlling the movement, position and compression force of a compression tool.

In another preferred embodiment of the invention, the method of forming a weld joint includes the step of performing a welding operation using a welding tool selected from the group consisting of gas welding tools, arc welding tools, resistance welding tools, thermite welding tools, laser welding tools, and electron-beam welding tools.

In another preferred embodiment of the invention comprises the step of using a welding apparatus having a welding tool for performing a welding operation and a tool for inducing a layer of compressive residual stress along the weld line to form a weld joint having improved physical properties.

In another preferred embodiment of the invention, the method of forming a weld joint includes the step of heating a selected region of a workpiece and inducing compression along the selected region.

In another preferred embodiment of the invention, the method of forming a weld joint includes the step of cooling a selected region of the workpiece prior to inducing a layer of compressive residual stress along the surface of the selected region.

In another preferred embodiment of the invention, the welding tool is capable of performing at least one welding operation, the welding operation being selected from the group consisting of gas welding, arc welding, resistance welding, thermite welding, Laser welding, and electron-beam welding.

In another preferred embodiment of the invention, the apparatus for forming a weld joint comprises a welding tool for performing a welding operation and a compression tool for inducing a layer of compressive residual stress along the surface of the weld joint and any heat affected regions.

In another preferred embodiment of the invention, the apparatus for forming a weld joint comprises a welding apparatus having a single-point of contact compression tool.

In another preferred embodiment of the invention, the apparatus for forming a weld joint comprises means for controlling the movement of the welding tool.

In another preferred embodiment of the invention, the apparatus for forming a weld joint comprises means for controlling the movement of the compression tool.

In another preferred embodiment of the invention, the apparatus for forming a weld joint comprises means for controlling the pressure being applied by the compression tool along the surface of a workpiece.

In another preferred embodiment of the invention, the welding apparatus comprises means for heating a region of a workpiece.

In another preferred embodiment of the invention, the welding apparatus comprises means for cooling a region of a workpiece.

Another preferred embodiment of the invention comprises a structure formed by welding and having a preferred residual stress pattern formed along the weld line.

Another preferred embodiment of the invention comprises a structure formed by a plurality of plates, the plates being secured in place by welding and having a selected compressive residual stress pattern therein.

In another preferred embodiment of the invention, the structure is selected from the group consisting of aircraft structures, marine structures, construction structures, automotive structures, and canisters, containers, and the like.

Accordingly, it would be desirable to have a method and an apparatus for performing the method of forming a weld joint having an improved finish and physical properties, including improved corrosion resistance and fatigue life over parts formed using conventional welding methods and apparatus.

It would also be desirable to have a method and an apparatus for performing the method of forming a weld joint that induces a selected compressive stress pattern along a weld line.

It would also be desirable to have a relatively inexpensive method and an apparatus for performing the method of forming a weld joint having a compressive stress layer formed along the weld line and further having a relatively well defined localized compressive stress zone.

It would also be desirable to have a method and an apparatus for performing the method of forming a weld joint which can induce a compressive stress layer along the surface of the weld joint and which provides a relatively smooth surface along the weld line.

Other features and advantages of the invention will be apparent from the following description, the accompanying drawings and the appended claims.

### BRIEF DESCRIPTION OF THE DRAWINGS

FIG. 1 is a schematic of the welding apparatus for implementing the method of forming a weld joint of the present invention showing the controller, positioning device, welding tool and the compression tool;

FIG. 2 is a schematic perspective view of a preferred embodiment of the welding apparatus of FIG. 1 showing the welding tool and the compression tool;

FIG. 3 is a partial schematic side view of the welding apparatus of FIG. 2;

FIG. 4 is a graph illustrating that a greater depth of compression can be achieved with increase loading in spherical ball burnishing (using a 0.75 in (1.9 cm) ball) at an elevated temperature of 400° F. (204° C.) as compared to the same process at room temperature;

FIG. 5 is a graph illustrating that an increase in surface tensile stress can be obtained by cooling the surface of the workpiece (plotted as a function of the temperature differential between the surface and the interior of the workpiece);

FIG. 6 is a schematic of another embodiment of the welding apparatus for implementing the method of forming a weld joint showing means for spraying a coolant to create a temperature gradient between the surface and the interior of the workpiece prior to and during the compression operation;

FIG. 7 is a schematic of another embodiment of the welding apparatus for implementing the method of forming a weld joint showing another means for delivering a coolant to create a temperature gradient between the surface and the interior of a workpiece prior to and during the compression operation;

FIG. 8 is a cross-sectional view of the welding apparatus of FIG. 7 taken along section A-A;

FIG. 9 is a graph illustrating the surface residual stress distribution induced in the surface of a workpiece using a conventional method of welding as compared to the method of welding of the present application; and

FIG. 10 is a graph illustrating the average percent cold work distribution relating to the methods of welding of FIG. 9.

### DETAILED DESCRIPTION OF THE PREFERRED EMBODIMENT

The present invention is directed to a new and novel method and apparatus for performing the method of forming a weld joint and, a more particularly, a method and apparatus for forming a weld joint which utilizes a controlled process of inducing a specific compressive residual stress pattern and degree of cold working and surface hardening along a weld line to improve the physical properties of the weld joint and the resulting final product. In a preferred embodiment of the invention, the welding apparatus comprises a welding tool for welding one or more workpieces, and a compression tool for inducing a layer of residual compressive stress in the surface of a workpiece. In another preferred embodiment of the invention, the method utilizes a process of inducing a specific and selected pattern of compressive residual stress and selected amount of cold working and surface hardening, such as by the process of controlled low plasticity burnishing, to improve the physical properties of the weld joint and the resulting final product.

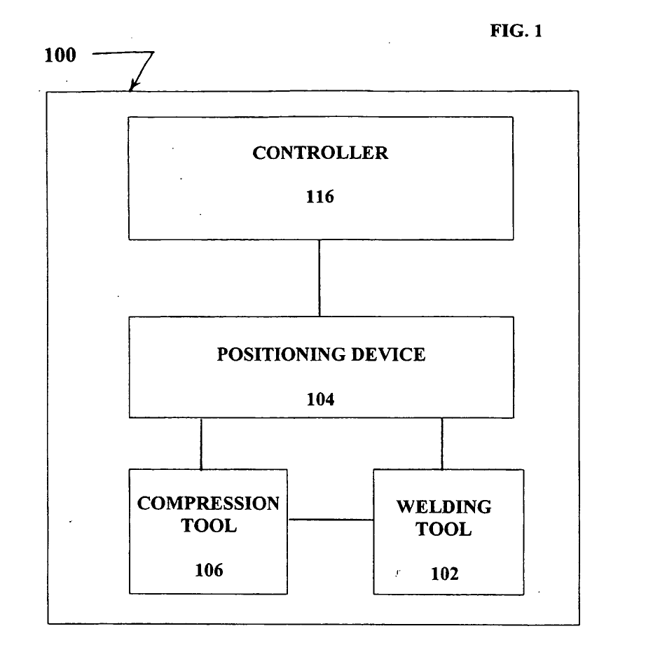

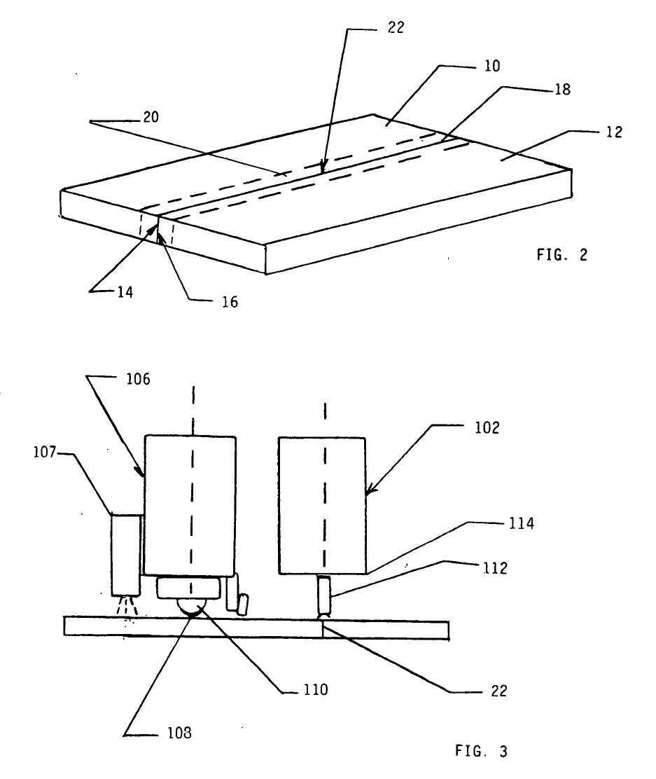

Referring to FIGS. 1, 2 and 3, a pair of workpieces 10, 12 having opposing ends 14, 16, respectively, are positioned to be mated together by welding. The welding apparatus 100 comprises a welding tool 102 having one or more welding heads effective for performing a conventional welding operation such as gas welding, arc welding, resistance welding, thermite welding, laser welding, ultrasonic welding, friction stir welding, and electron-beam welding. Preferably, the welding apparatus 100 further comprises a compression tool 106 for producing a zone of deformation and a relatively deep layer of compression along the weld line 18 and any heat affected regions 20, which are typically adjacent to the weld line 18. While various compression tools have been developed for inducing a layer of compressive residual stress in the surface of a workpiece, preferably, the compression tool 106 is a single-point burnishing tool for implementing the method of the present invention. As shown in FIG. 3, the single-point burnishing operation is performed using the forward most tip 108 of a burnishing ball 110 which is caused to pass over the weld line 18 (FIG. 2) and any heat affected regions 20 in a rolling motion to induce deep compression. The compression tool 106 operates by forcing the burnishing ball 110 against the surface of the workpiece 10, 12 and along the weld line 18 to produce azone of deformation and to induce a deep layer of compression within the surface of the workpieces 10, 12.

The welding tool 102 and the compression tool 106 can be mounted onto a single, or on separate, conventional positioning device 104 that can be manually or automatically operated and can be controlled using a conventional controller 116 operating under computer software control for automatically controlling the positioning of the welding tool 102 and the compression tool 106. The positioning device 104 may also include belt and/or gear drive assemblies (not shown) powered by servomotors (not shown), as is known in the art and can be in operable communication with the controller 116 through suitable wiring (not shown).

During the welding process, the welding tool 102 is moved along the weld line 18 formed by the opposing ends 14, 16 of the workpieces 10, 12, respectively, to weld the ends 14, 16 of the workpieces 10 and 12 together. It should be understood that in another preferred embodiment of the invention, the welding tool 102 can be fixed and the workpieces 10, 12 can be moved relative to the welding tool 102. A layer of residual compressive stress is then induced along the weld line 18 and any heat-affected regions 20 produced by the heat generated during the welding process, using the compression tool 106. It should be understood that the compression tool 106 can also be utilized to induce a layer of residual compressive stress to other regions along the surfaces of the workpieces 10, 12 to produce a final part having a desired compressive stress pattern.

Preferably, conventional x-ray diffraction techniques are used to analyze the area along the weld line 18 and the heat affected regions 20, for determining a desired compressive stress pattern and the amount of cold working and surface hardening required to optimize the physical characteristics of the weld joint 22 and the resulting final product. The burnishing ball 110 can then be passed in a selected pattern and pressure across the weld line 18, and any heat affected regions 20, to induce the desired compressive stress pattern with the desired amount of cold working and surface hardening. It has been found that the method of single-point burnishing, applied in a single-pass or multiple passes of reduced compressive force, can be an effective method for producing compressive residual stresses following tensile deformation of the surface to a certain depth within the weld joint 22, and any heat affected regions 20, and to produce deep compression with minimal cold working. It has also been found that this single-point burnishing method can be used to produce a final part with less cold work and surface hardening than a part subjected to conventional shot peening or gravity peening. Further, the residual compressive stress developed by this method penetrates to a greater depth within the surface of the workpiece than developed by conventional methods, such as shot peening and conventional burnishing. The amount of cold working and surface hardening can also be varied as part of the process to optimize the physical properties of the weld joint and the final product and will depend on the particular material being welded and the environment which the part will be subjected to during its life. It has been found, however, that by cold working the surfaces of the welded workpieces 10 and 12 along the weld line 18, and any heat affected regions 20, by less than about 5%, and preferably less than about 2%, results in a weld joint 22 having longer retention of compressive residual stress at elevated temperature, less rapid relaxation under cyclic loading, and minimizes the alteration of the residual stress field during tensile or compressive overload than weld joints and parts formed using conventional cold working and surface hardening processes.

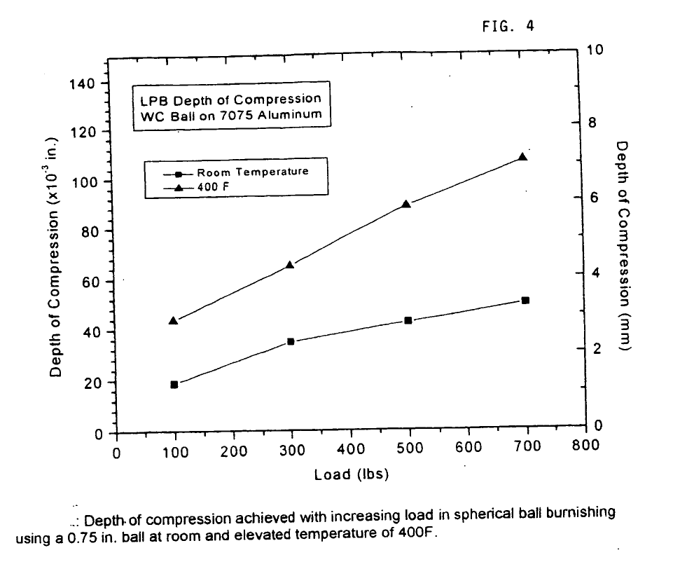

It has also been found that by inducing a layer of compressive residual stress in the surface of a workpiece, such as by burnishing, along regions having elevated temperature, such as produced during the welding operation or by some other heating means, produces residual stresses that are more stable when subjected to elevated temperature. Such stability is believed to be attributed to strain aging which occurs during the warm deformation process that leads to more diffuse dislocation structures and pinning of dislocations by solute atoms and/or precipitates. It has also been found that by performing the compression operation with the surface of the workpiece heated to an elevated temperature, rather than at room temperature, produces a deeper compressive residual stress layer. Because of the reduction of the workpiece yield strength, plastic deformation extends to a greater depth thereby producing deeper compression, as well as deeper penetration of the burnishing tool, thereby producing more lateral flow of surface material and higher surface compression. As illustrated in FIG. 4, the depth of compression, calculated using conventional finite element methods and published yield strengths, achieved by burnishing a material, such as 7075-T6 aluminum, at a heated temperature, such as 400° F. (204° C.), is over twice the depth of compression achieved by burnishing at room temperature. The depth of compression achieved increases with the increasing burnishing load.

As shown in FIGS. 1, 2 and 3, a preferred embodiment of the welding apparatus 100 is shown comprising a conventional welding tool 102 effective for performing a welding operation. The welding tool 102 includes a welding probe 112, such as an electrode or other heating source, extending downwardly from the shoulder 114 of the welding tool 102. During operation, the welding probe 112 is brought into close proximity or contact with the opposing ends 14 and 16 of the workpieces 10 and 12, respectively, and moved along the weld line 18 which heats and softens the material of the workpieces 10 and 12 in the vicinity of the welding probe 112 creating heated, melted or plasticized, regions 20 along the welding line 18 in the workpieces 10 and 12. After the workpieces 10 and 12 are welded together, the compression operation is performed using the compression tool 106, such as the burnishing tool previously described herein, to induce a layer of residual compressive stress along the surface of the weld line 18, and any heat affected regions 20, to form a weld joint 22. As previously stated, the compression operation is preferably performed while the weld line 18 and any heat affected regions 20 are at their elevated temperature produced by the welding process. The positioning device 104 (FIG. 1) can be mounted to a conventional controller 116 having a processor for storing system software or program (not shown) to automatically control the pressure being exerted by the compression tool 106 at particular points along the welding line 18, and any heat affected regions 20, and other selected regions, thereby controlling the magnitude of compression being induced. The controller 116 may also be programmed to operate the positioning device 104 to control the direction of movement of the compression tool 106 to produce the desired stress distribution. In a preferred embodiment of the invention, the compression operation can be performed along the surface regions of the workpieces that are at an elevated temperature caused by the welding process. It should be understood that the compression operation can also be performed along regions that are not at an elevated temperature or can be performed along regions that have an elevated temperature produced by other means such as by induction heating, torch, laser, heated fluid, and the like. For purposes of illustration, as shown in FIG. 3, the welding apparatus 100 is shown having a heating means 107 mounted to the compression tool 106 for heating and elevating the surface temperature of the workpieces 10, 12 just prior to performing the compression operation.

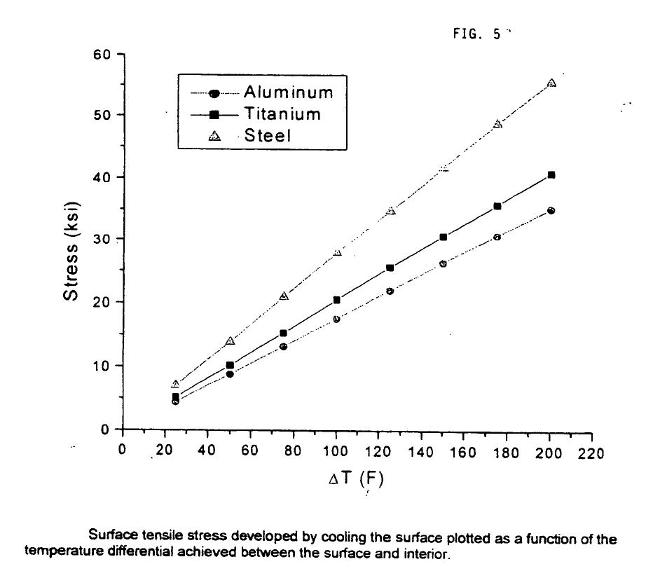

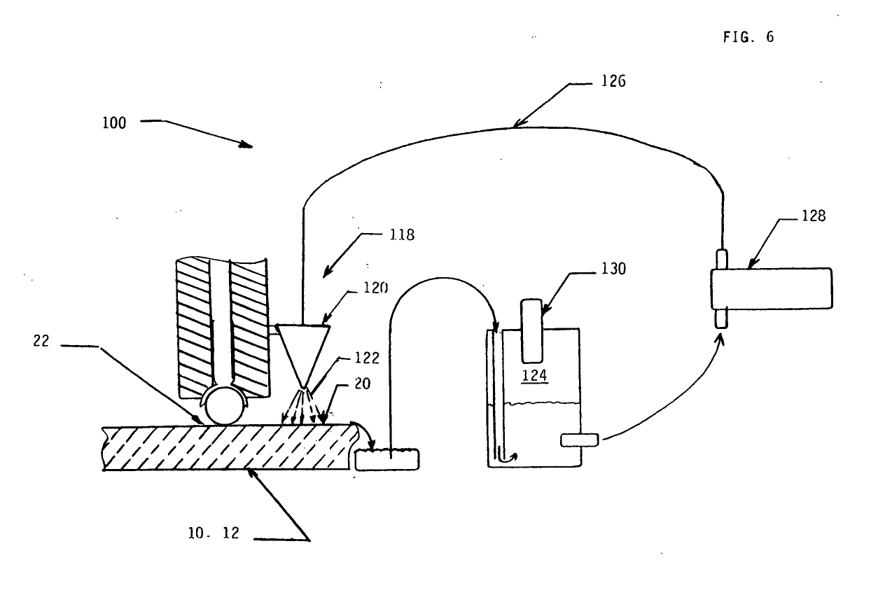

Referring to FIGS. 1 and 6, in another preferred embodiment of the invention, a fluid coolant 122 is sprayed along the weld line 18, and any heat affected regions 20, prior to performing the compression operation. It has been found that cooling, such as by applying a coolant 122, the regions 20 heated during the welding operation, and other selected regions along the surfaces of the workpieces 10, 12, creates a tensile pre-stress condition prior to deformation by the compression tool 106. Tension is temporarily present in the surface layer while a temperature gradient within the surface is maintained by contact with the coolant 122. The surface layer is then more easily deformed in tension during the compression operation, thereby creating higher surface compression. After the compression operation is complete, the temperature of the workpieces will re-equilibrate and return to ambient temperature. Further, it has also been found that as the interior of a heated workpiece contracts, the surface will be drawn further into compression and that the increase in compression upon cooling will be approximately equal to the magnitude of the thermal strain induced by the coolant. FIG. 5 illustrates the tensile stress induced at the surface of the workpiece, such as formed from aluminum, titanium, or steel alloys, by maintaining a temperature gradient between the upper surface and the interior surface of the workpiece. The typical lower surface compression achieved by the Hertzian loading, such as produced with a spherical burnishing ball, is thus increased by the use of a coolant being applied along the heated weld line, and any other heated regions, as well as any other surface areas of the workpieces.

Referring now to FIGS. 1 and 6, for illustrative purposes, another preferred embodiment of the welding apparatus 100 is shown having means for cooling 118 the formed weld joint 22, any heat affected regions 20, and other selected regions of the surfaces of the workpieces 10, 12. In a preferred embodiment of the invention, the means for cooling 118 comprises a conventional fluid sprayer 120 effective for spraying a coolant 122 onto the surfaces of the workpieces 10, 12 to be placed into compression. The fluid sprayer 120 is connected with a coolant supply or reservoir 124 through a hose or conduit 126. A conventional pump 128 operates to pump coolant 122 from the coolant supply or reservoir 124 through the hose or conduit 126 to be sprayed onto the surfaces of the workpieces 10, 12 prior to receiving compression. As shown, the means for cooling 118 can further comprise means for returning the sprayed coolant 130, such as a vacuum means, to the fluid supply or reservoir 124.

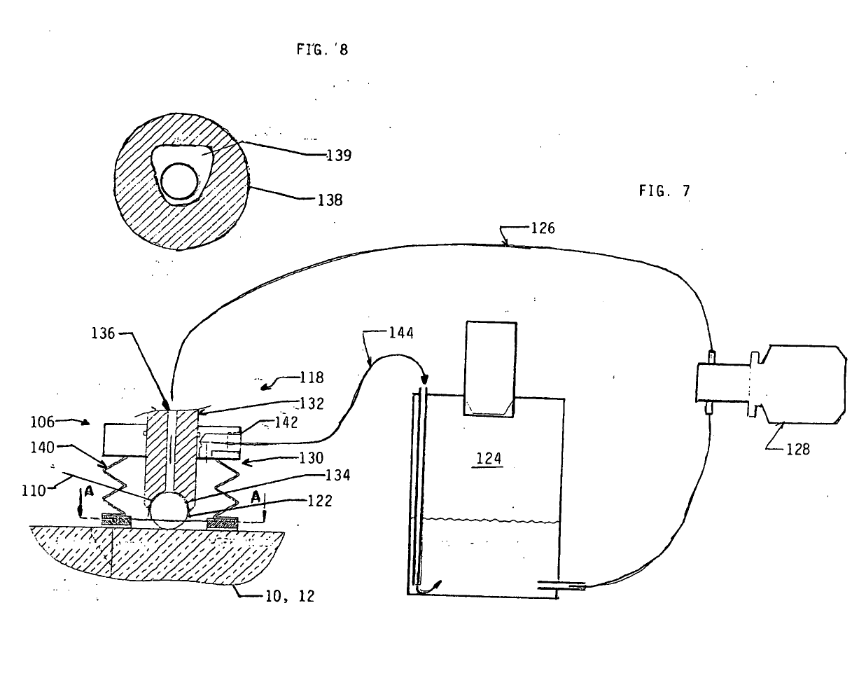

In another preferred embodiment of the invention, the means for cooling 118 can be incorporated into the compression tool 106. Referring to FIGS. 7 and 8, for illustrative purposes, another embodiment of the compression tool 106, such as a conventional burnishing apparatus is shown having means for cooling 118 incorporated therein. As shown, the compression tool 106 includes a socket 132 having a ball seat 134 which is essentially spherical in shape and adapted to the surface of the burnishing ball 110 which is disposed within the ball seat 134. The socket 132 is further provided with a fluid passage 136 in flow communication with the ball seat 134 and to an external coolant supply or reservoir 124. In operation, coolant 122 is fed under pressure from the coolant supply or reservoir 124 by a conventional pump 128 through a hose 126 to the fluid passage 136 and the ball seat 134. Pressure then forces the coolant 122 around the surface of the burnishing ball 110 and outwardly onto the surface of the workpiece 10, 12. By adjusting the pressure being generated by the pump 128, the desired amount of coolant 122 penetrating around the burnishing ball 110 and onto the surface of the workpiece 10, 12 can be obtained. It should be understood, the coolant 122 could also be used as a lubricating fluid for the burnishing ball 110 and the burnishing operation. The means for cooling 118 can further comprise means for cooling the coolant (not shown) to a desired temperature and means for returning the used coolant 130, such as a vacuum means, to the fluid supply or reservoir 124. As shown, in a preferred embodiment of the invention, the compression tool 106 is provided with a pad 138 having a convoluted boot 140 mounted to the socket 132 to prevent coolant 122 from flowing across the surface of the workpiece 10, 12. As shown, the pad opening 139 can be sized and shaped to hold more or less coolant, to optimize the temperature gradient through the workpieces. The boot 140 includes an outlet 142, which is in flow communication with the coolant supply or reservoir 124 by a hose or conduit 144. In operation, vacuum pressure is generated inside the coolant supply or reservoir 124 which operates to draw outside air and coolant 122 that has been expelled from the socket 132 onto the surface of the workpiece 10, 12 and contained within the boot 140 back to the coolant supply or reservoir 124.

It should be understood that various types of coolants and methods for distributing such coolants onto the surfaces of the workpieces to create a surface temperature gradient between the surface and the interior of the workpiece may be used without departing from the invention. For example, the coolant may be in the form of a cooled gas which can dissipate after being directed onto the surface of the workpiece. In addition, the temperature and the amount of coolant used can be varied to provide the desired temperature gradients. Coolants in the form of liquid may also be applied and removed in various ways, such as evaporation, run off, or recycled.

It should also now be understood that the method and apparatus of the present application provides a new and novel means for forming a weld joint having improved physical properties. In a preferred embodiment of the invention, compressive residual stresses are induced along the surfaces of the workpieces having regions of elevated surface temperatures as a result of the welding process or by heating using other means, such as induction heating, torch, laser, steam, and the like. Compressive residual stresses may also be induced along surfaces of the workpieces having regions that have been cooled, such as by means of a cooling fluid. By properly selecting the surface temperature gradients and the compression parameters, parts, including parts having weld joints, may be formed having improved physical properties.

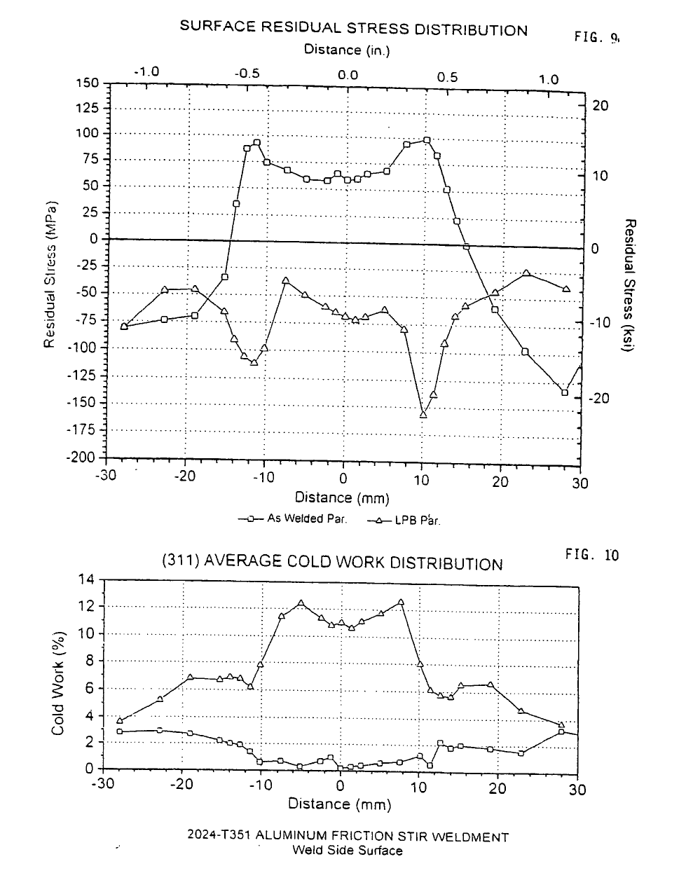

Accordingly, the method and the apparatus for performing the method of the subject invention is relatively inexpensive and provides an effective means of welding which provides a compression force along the weld line, and any heat affected regions, to induce compressive stress in a well defined localized area with a controlled amount of cold working and surface hardening. Referring to FIG. 9, the inversion into tension of the surface of a workpiece after a welding operation is shown compared to the surface of a workpiece having been treated by the method of the present application. Upon welding, the surface may actually invert from compression into a relative high level of tension, thereby significantly reducing fatigue life and stress corrosion resistance of the weld joint and accordingly the final part, as previously stated herein. By minimizing the amount of cold working and surface hardening, as shown in FIG. 10, it has been found that the method of the present application will induce a layer of compressive residual stress along the surface of the weld joint, and any heat affected regions, and will result in a weld joint and a final part having improved physical properties, particularly at elevated temperature, as well as minimize the alteration of the residual stress field during tensile or compressive overload.

As described and shown herein above, the method of forming a weld joint of the present application has great advantage over prior welding methods as it enables the finished weld joint and accordingly the final part, to achieve enhanced fatigue strength and stress corrosion resistance while providing a part having a good surface finish. Further, coupling the welding process with the compression operation into a single process, permits effective use of the heat generated during the welding operation resulting in a relatively low cost procedure, requiring no expensive and/or time consuming after-weld treatments, and which is effective for inducing a deep layer of compression, with a minimal amount or a controlled amount of cold working and surface hardening, along the surface of the weld joint and any heat affected regions. This is particularly significant for final parts that were formed using extensive welding operations where the cost of a process requiring a second-pass would be prohibitive. In addition, surface roughness is also improved without requiring a relatively expensive and time consuming process requiring a second-pass.

In another preferred embodiment of the invention, the final part is a structure, such as an automobile structure, an aircraft structure, a construction structure, a marine structure, and the like, and is formed having a plurality of weld joints. Each weld joint is formed by the method and apparatus of the subject invention, as previously described, and includes a layer of compression residual stress along the surface of the joint and any heat affected regions.

In another preferred embodiment of the invention, a structure comprising a plurality of plates secured in place by the welding method and apparatus as previously described.

It should also now be understood to those skilled in the art that the method of forming a weld joint and the apparatus for performing the method of the subject application greatly increases the type of parts that can be economically manufactured by welding rather than by use of bolts and rivets. Such parts are particularly found in the aerospace industry, such as in the manufacture of aircraft fuselage and wing skins and supports, where weight considerations are of the up most importance. Such parts are also found in the marine industry, construction industry, automotive industry, and in general manufacturing.

It should also now be understood to those skilled in the art that the method of forming a weld joint and the apparatus for performing the method of the subject application results in final parts having weld joints with improved physical properties and are less likely to suffer from corrosion. This can be particularly significant for canisters and containers that are to be used for long periods of time and where failure can be harmful or disastrous.

While the method and apparatus described constitute preferred embodiments of the invention, it is to be understood that the invention is not limited to the precise method and apparatus, and that changes may be made therein without departing from the scope of the invention which is defined in the appended claims.

1. A method of forming a weld joint comprising the steps of:
performing a welding operation along a weld line to form a weld joint and heated regions along the surfaces of the workpieces; and
performing a compression operation to induce a deep layer of compression in the surfaces of the workpieces;
wherein the welding operation forms regions having an elevated surface temperature; and
wherein the compression operation is performed along the weld line and regions having an elevated surface temperature.

2. The method of claim 1 wherein the amount of surface cold working is less than about 2 percent.

3. The method of claim 1 wherein the amount of surface cold working is less than about 5 percent.

4. The method of claim 1 wherein inducing a deep layer of compression is performed using a burnishing process.

5. The method of claim 1 further comprising the step of passing a single-point compression tool in a predetermined pattern across the weld line to induce a desired compressive stress pattern having a selected amount of cold working and surface hardening.

6. The method of claim 1 wherein the welding operation and the compression operation are performed in a single pass.

7. The method of claim 1 further comprising the step of varying the amount of surface cold working to achieve a desired residual stress pattern.

8. The method of claim 1 further comprising the step of cooling a region along the surface of at least one workpiece prior to performing the compression operation.

9. The method of claim 1 further comprising the step of creating a surface temperature gradient within a region of a workpiece and performing the compression operation along the region.

10. A method of forming a weld joint comprising the steps of:
positioning at least two workpieces together forming a weld line;
performing a welding operation along the weld line to form a weld joint;
creating a surface temperature gradient within regions of the workpieces; and
performing a compression operation to induce a layer of residual compressive stress along the regions.

11. The method of claim 10 wherein the regions are heated to elevated temperatures.

12. The method of claim 10 wherein the regions are cooled to lower temperatures.

13. The method of claim 10 wherein the amount of cold working of the surface of the workpieces is less than about 5 percent.

14. The method of claim 10 wherein the amount of cold working of the surface of the workpieces is less than about 2 percent.

15. The method of claim 10, wherein the pattern of burnishing is controlled to induce a selected residual stress pattern along the surfaces of the workpieces.

16. The method of claim 10 wherein the welding operation and the compression operation are performed in a single pass.

17. An apparatus for forming a weld joint, the apparatus comprising:
means for performing a welding operation to weld at least two workpieces together; and
means for inducing a deep layer of compression within the surface of the workpieces;
wherein said means for performing the welding operation is selected from the group consisting of gas welding, arc welding, resistance welding, thermite welding, laser welding, and electron-beam welding.

18. The apparatus of claim 17 further comprising means for creating a surface temperature gradient within regions of the workpieces.

19. The apparatus of claim 17 wherein said means for inducing a deep layer of compression within the surface of the weld joint comprises a burnishing device.

20. The apparatus of claim 17 further comprising a controller for automatically controlling the movement of said welding tool and the compression tool.

21. The apparatus of claim 17 further comprising means for depositing a coolant along the surfaces of the workpieces.

22. The apparatus of claim 17 further comprising means for heating selected regions of the surfaces of the workpieces.
